(19) United States
(12) Patent Application Publication
(10) Pub. No.: US 2004/0130377 A1
(43) Pub. Date: Jul. 8, 2004

(54) Switched capacitor amplifier circuit and electronic device

(76) Inventors: Akira Takeda, Chiba-shi (JP); Hirokazu Yoshizawa, Chiba-shi (JP)

Correspondence Address: ADAMS & WILKS, 50 Broadway, 31st Floor, New York, NY, 10004, US

(21) Appl. No.: 10/721,521

(22) Filed: Nov. 24, 2003

(30) Foreign Application Priority Data
Nov. 26, 2002 (JP) 2002-342439
Jul. 30, 2003 (JP) 2003-203921

(51) Int. Cl. G06G 7/18

(52) U.S. Cl. 327/337

(57) ABSTRACT

A switched capacitor amplifier circuit includes an operational amplifier; a plurality of switch circuits; a plurality of capacitors; and two input terminals; in which a standard voltage and a reference voltage are provided, and noise components of the standard voltage and the reference voltage are made in phase to reduce noises caused by offset voltage adjustment.

### BACKGROUND OF THE INVENTION

1. Field of the Invention

The present invention relates to a switched capacitor amplifier circuit that cancels an offset voltage and to an electronic device using the switched capacitor amplifier circuit.

2. Description of the Related Art

A conventional offset cancel switched capacitor amplifier circuit is structured such that an offset voltage of an operational amplifier is stored in a capacitor so as not to output the offset voltage (for example, refer to U.S. Pat. No. 4,543,534 “Offset compensated switched capacitor circuits”).

An example of a circuit structure of the conventional offset cancel type switched capacitor amplifier circuit is shown in FIG. 2. In a reset phase f1, switch circuits 123, 124, 125, 128, 129 and 132 are closed. In this structure, capacitors 101, 102, 103 and 104 are discharged through the switch circuits 123, 124, 125 and 129. After a given period of time, the switch circuits 123, 124, 125, 128, 129 and 132 are opened, and the reset phase f1 is completed.

Subsequently, the phase is shifted to a sampling phase f2. The switch circuits 121, 122, 126, 130, 128 and 132 are closed. The voltage of the input terminal 141 are charged in the capacitor 101 as electric charges, and the voltage of the input terminal 142 are charged in the capacitor 102 as electric charges as well. The electric charges in the capacitor 103 vary as much as a change of the electric charges in the capacitor 101. At the same time, the electric charges in the capacitor 104 vary as much as a change of the electric charges in the capacitor 102. As a result, the voltage of the output terminal 151 varies.

The voltage of the output voltage 151 is given by the following expression:

Vout=−(C1/C2)*(Vin1−Vin2)

The input offset voltage of the operational amplifier is charged in the capacitors 101 and 102 in the reset phase f1. A variation in the potential between both ends of the capacitor 101 in the sampling phase f2 is a difference between the voltage of the input terminal 141 and the standard voltage given to the switch 123. Similarly, a variation in the potential between both ends of the capacitor 102 in the sampling phase f2 is a difference between the voltage of the input terminal 142 and the standard voltage given to the switch 124. Accordingly, The variation in the voltage charged between both ends of the capacitors 101 and 102 becomes a difference between the input voltage and the standard voltage, and the offset voltage is not included in the variation. For that reason, the offset voltage of the operational amplifier is not amplified, and cancelled.

In addition, when the input voltage per se has the offset voltage, the reference voltage is used in addition to the standard voltage, and a difference between the reference voltage and the standard voltage is controlled so as to cancel the offset voltage of the input voltage. In the switched capacitor amplifier circuit structured as described above, because the offset voltage of the input voltage is cancelled, no offset error occurs in the output.

However, in the conventional switched capacitor amplifier circuit, there arises such a drawback that the noises of the standard voltage and the reference voltage for canceling the offset voltage of the input voltage are amplified and outputted.

### SUMMARY OF THE INVENTION

In order to solve the above problem, according to the present invention, the standard voltage and the reference voltage are generated from the same voltage source by resistor division to make the standard voltage noise and the reference voltage noise in phase, thus being capable of canceling the noises. Also, nodes that give the standard voltage and the reference voltage are replaced by each other, thereby being capable of being adaptive to both cases in which the polarity of the offset voltage is positive and negative.

### BRIEF DESCRIPTION OF THE DRAWINGS

In the accompanying drawings:

FIG. 1 is a structural diagram showing a switched capacitor amplifier circuit in accordance with the present invention; and

FIG. 2 is a structural diagram showing a conventional switched capacitor amplifier circuit.

### DETAILED DESCRIPTION OF THE PREFERRED EMBODIMENT

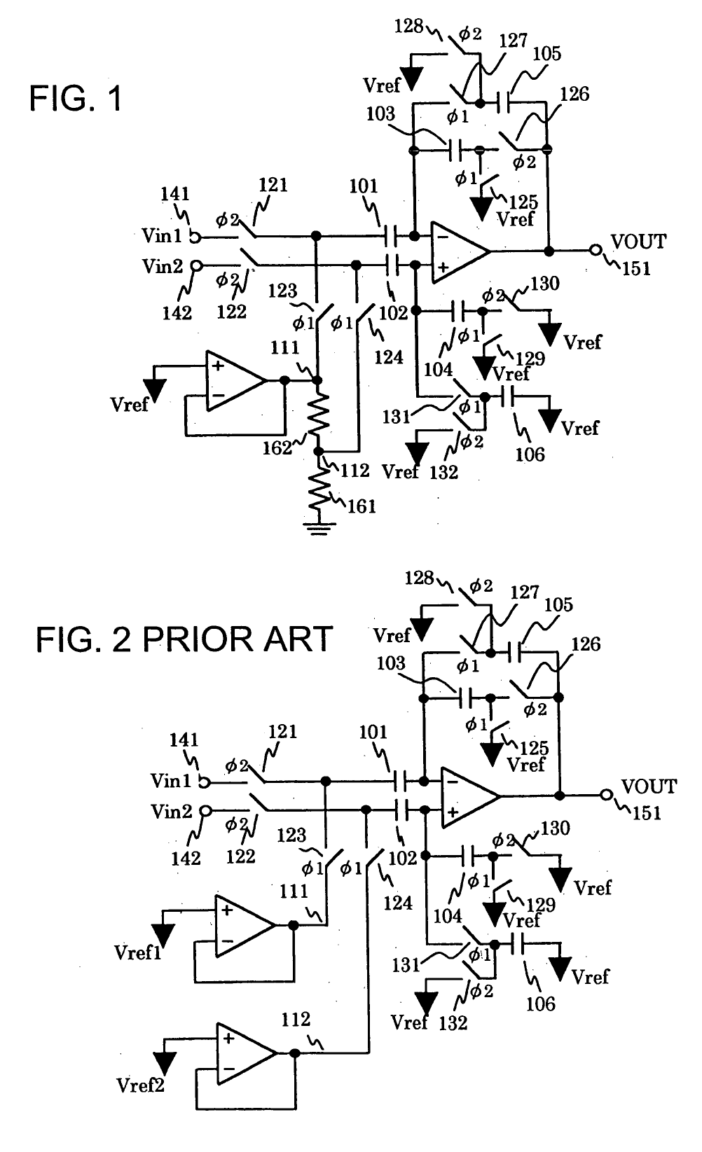

Hereinafter, a preferred embodiment of the present invention will be described with reference to the accompanying drawings. FIG. 1 is an example of the structural diagram of the switched capacitor amplifier circuit in accordance with the present invention. In the reset phase f1, the switch circuit 123 is closed, the capacitor 101 is connected to a node 111, the switch circuit 124 is closed, and the capacitor 102 is connected to a node 112. At the same time, the switch circuits 125 and 129 are closed, and the electric charges in the capacitors 103 and 104 are discharged. After a given period of time, the switch circuits 123, 124, 125 and 129 are opened, to thereby complete the reset phase f1. The electric charges charged in the capacitor 101 in the reset phase f1 are represented as follows:

q=C1*VREF

The electric charges charged in the capacitor 102 are represented as follows:

q=C1*(VREF−VOFF)

Then, the phase is shifted to the sampling phase f2. The switch circuits 121, 122, 126, 130, 128 and 132 are closed. The voltage of the input terminal 141 are charged in the capacitor 101 as electric charges, and the voltage of the input terminal 142 are charged in the capacitor 102 as electric charges as well. The electric charges in the capacitor 103 vary as much as a change of the electric charges in the capacitor 101. At the same time, the electric charges in the capacitor 104 vary as much as a change of the electric charges in the capacitor 102. As a result, the voltage of the output terminal 151 varies. In the sampling phase f2, the electric charges charged in the capacitor 101 is represented as follows:

q=C1*Vin1

The electric charges charged in the capacitor 102 are represented as follows:

q=C1*Vin2

Therefore, a variation in the amount of electric charges in the capacitor 101 after the phase has changed from the reset phase f1 to the sampling phase f2 is represented as follows:

Δq=C1*(Vin1−VREF)

A variation in the electric charge in the capacitor 102 is represented as follows:

Δq=C1*(Vin2−(VREF−VOFF))

When the voltage Vin1 of the input terminal 141 is composed of a signal voltage Vinp and an offset voltage Vos, and the voltage Vin2 of the input terminal 142 is composed of only the signal voltage Vinn, the voltage of the output terminal 151 is represented as follows:

$$\begin{matrix}Vout = - ( C1 / C2 ) * [ ( Vin1 - Vin2 ) - ( VREF - ( VREF - VOFF ) ) ] \\ = - ( C1 / C2 ) * [ ( Vinp + Vos - Vinn ) - VOFF ] \\ = - ( C1 / C2 ) * [ ( Vinp - Vinn ) + ( Vos - VOFF ) ]\end{matrix}$$

When adjustment is made to satisfy Vos=VOFF, the following expression is satisfied:

Vout=−(C1/C2)*(vinp−Vinn)

As a result, the offset voltage Vos of the input signal Vin1 can be canceled.

In this event, in the case where VOFF is obtained from two voltage sources VREF1 and VREF2, VOFF=VREF1−VREF2 is satisfied, and the noise components of VREF1 and VREF2 are synthesized. In the present invention, because VOFF is obtained from VREF by resistance division, VOFF is lessened as much as the resistance divided component of the noises of VREF.

As described above, in the circuit system according to the present invention, the offset voltage of the input voltage is canceled by a low noise, thereby being capable of amplifying only the signal component.

Similarly, in a perfect differential circuit having two inputs and two outputs, it is apparent that the present invention can be implemented. With the perfect differential circuit structure, the in-phase noise can be further reduced.

Also, the circuit shown in this embodiment is an example of the switched capacitor amplifier circuit, and in a switch capacitor amplifier circuit of another type, it is apparent that the present invention can be also implemented.

In the case where the value of the offset voltage included in the input voltage is known in advance and is constant, the resistance may be a fixed resistor. However, in the case where the voltage of the offset voltage included in the input voltage is unknown, the resistor is structured by a variable resistor that can adjust the resistance in accordance with the offset voltage, thereby being capable of adjusting the offset voltage while watching the output voltage.

In FIG. 1, some of the resistors that constitutes the resistor 161 are connected in parallel with the switch, and the switch is opened/closed on the basis of data written in a storage device, thereby being capable of obtaining a desired voltage.

The offset voltage of the input voltage is cancelled at the low noise, and only the signal component can be amplified.

What is claimed is:

1. A switched capacitor amplifier circuit, comprising:
an operational amplifier;
a plurality of switch circuits;
a plurality of capacitors; and
two input terminals;
wherein a standard voltage and a reference voltage are provided, and noise components of the standard voltage and the reference voltage are made in phase to reduce noises caused by offset voltage adjustment.

2. A switched capacitor amplifier circuit, comprising:
a first input terminal to which a first input signal is inputted;
a second input terminal to which a second input signal is inputted;
a first capacitor to which a signal based on an output of the first input terminal is inputted;
a second capacitor to which a signal based on an output of the second input terminal is inputted;
an operational amplifier that compares a signal based on an output of the first capacitor with a signal based on an output of the second capacitor to output a signal;
a first reference voltage terminal to which a first reference voltage that supplies electric charges to the first capacitor is applied; and
a second reference voltage terminal to which a second reference voltage that supplies electric charges to the second capacitor is applied,
wherein at least one of the first reference voltage and the second reference voltage is adjusted so that a difference between the first reference voltage and the second reference voltage coincides with an offset voltage between the first input terminal and the second input terminal.

3. A switched capacitor amplifier circuit as claimed in claim 2, wherein the first reference voltage has a temperature characteristic, and
when an offset voltage between the first input terminal and the second input terminal has the temperature characteristic, the first reference voltage sets the temperature characteristic so that a difference in voltage value between the first reference voltage and the second reference voltage coincides with the offset voltage between the first input terminal and the second input terminal.

4. A switched capacitor amplifier circuit, comprising:
an operational amplifier;
first and second capacitors and a first switch circuit each having one end connected to one of input terminals of the operational amplifier, respectively;
third and fourth capacitors and a second switch circuit each having one end connected to one of input terminals of the operational amplifier, respectively;
third and fourth switch circuits each having one end connected to the other end of the first capacitor;
fifth and sixth switch circuits each having one end connected to the other end of the third capacitor;
a first reference voltage connected to the other end of the third switch circuit;
a second reference voltage connected to the other end of the fifth switch circuit;
seventh and eighth switch circuits each having one end connected to the other end of the second capacitor;
ninth and tenth switch circuits each having one end connected to the other end of the fourth capacitor;
an eleventh switch circuit and a fifth capacitor which are connected to the other end of the first switch circuit; and
a twelfth switch circuit and a sixth capacitor which are connected to the other end of the second switch circuit;
wherein the other end of the fifth capacitor and the other end of the second switch circuit are connected to the output terminal of the operational amplifier,
the other end of the eight switch circuit, the other end of the tenth switch circuit, the other end of the eleventh switch circuit and the other end of the twelfth switch circuit are connected to the second reference voltage, and
the other ends of the fourth and sixth switch circuits are input terminals.

5. An electronic device having the switched capacitor amplifier circuit as claimed in claim 4.

6. An electronic device having the switched capacitor amplifier circuit as claimed in claim 3.

7. An electronic device having the switched capacitor amplifier circuit as claimed in claim 2.

8. An electronic device having the switched capacitor amplifier circuit as claimed in claim 1.
